(19) United States
(12) Patent Application Publication
(10) Pub. No.: US 2025/0291540 A1
(43) Pub. Date: Sep. 18, 2025

(54) ENABLING VOLUME CONTROL SWIPE FEATURES BASED ON SPEAKERS AND MICROPHONE USAGE OF DEVICES WITH TOUCHSCREENS

(71) Applicant: Lenovo Enterprise Solutions (Singapore) Pte. Ltd., New Tech Park (SG)

(72) Inventor: Ramakrishna Potluru, Nellore (IN)

(21) Appl. No.: 18/606,535

(22) Filed: Mar. 15, 2024

(51) Int. Cl. G06F 3/16; G06F 3/04847; G06F 3/04855; G06F 3/0488

(52) U.S. Cl. CPC G06F 3/165; G06F 3/04847; G06F 3/04855; G06F 3/0488; G06F 3/167

(57) ABSTRACT

A method for volume control swiping includes enabling volume control swiping for landscape mode and/or portrait mode of a touchscreen of a computing device. In response to detecting a speaker being active, the method includes detecting swiping in a landscape direction during operation of the computing device in the landscape mode and, in response to the volume control swiping being enabled for the landscape mode, adjusting a volume setting of the computing device in response to the detected swiping of the touchscreen in the landscape direction. In response to detecting a speaker being active, the method includes detecting swiping in a portrait direction during operation of the computing device in the portrait mode, and in response to volume control swiping being enabled for the portrait mode, adjusting the volume setting of the computing device in response to the detected swiping of the touchscreen in the portrait direction.

### FIELD

The subject matter disclosed herein relates to volume control and more particularly relates to volume control using swiping when speakers or a microphone are active.

### BACKGROUND

Computing devices often include a touchscreen that allows control of the computing device based on swiping on the touchscreen.

### BRIEF SUMMARY

A method for volume control swiping is disclosed. An apparatus and computer program product also perform the functions of the method. The method includes enabling volume control swiping for a landscape mode and/or a portrait mode of a touchscreen of a computing device. In response to detecting a speaker being active during execution of an application on the computing device, the method includes detecting swiping on the touchscreen in a landscape direction during operation of the computing device in the landscape mode and, in response to the volume control swiping being enabled for the landscape mode, adjusting a volume setting of the computing device in response to the detected swiping of the touchscreen in the landscape direction. Also, in response to detecting a speaker being active during execution of an application on the computing device, the method includes detecting swiping on the touchscreen in a portrait direction during operation of the computing device in the portrait mode, and in response to volume control swiping being enabled for the portrait mode, adjusting the volume setting of the computing device in response to the detected swiping of the touchscreen in the portrait direction.

An apparatus for volume control swiping includes a processor and non-transitory computer readable storage media storing code. The code is executable by the processor to perform operations that include enabling volume control swiping for a landscape mode and/or a portrait mode of a touchscreen of a computing device, and in response to detecting a speaker being active during execution of an application on the computing device, the operations include detecting swiping on the touchscreen in a landscape direction during operation of the computing device in the landscape mode, and, in response to the volume control swiping being enabled for the landscape mode, adjusting a volume setting of the computing device in response to the detected swiping of the touchscreen in the landscape direction. Also in response to detecting a speaker being active during execution of an application on the computing device, the operations include detecting swiping on the touchscreen in a portrait direction during operation of the computing device in the portrait mode and, in response to volume control swiping being enabled for the portrait mode, adjusting the volume setting of the computing device in response to the detected swiping of the touchscreen in the portrait direction.

A program product for volume control swiping includes a non-transitory computer readable storage medium storing code. The code is configured to be executable by a processor to perform operations that include enabling volume control swiping for a landscape mode and/or a portrait mode of a touchscreen of a computing device. In response to detecting a speaker being active during execution of an application on the computing device, the operations include detecting swiping on the touchscreen in a landscape direction during operation of the computing device in the landscape mode, and in response to the volume control swiping being enabled for the landscape mode, adjusting a volume setting of the computing device in response to the detected swiping of the touchscreen in the landscape direction. Also, in response to detecting a speaker being active during execution of an application on the computing device, the operations include detecting swiping on the touchscreen in a portrait direction during operation of the computing device in the portrait mode, and in response to volume control swiping being enabled for the portrait mode, adjusting the volume setting of the computing device in response to the detected swiping of the touchscreen in the portrait direction.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating an apparatus for volume control swiping in a computing device with a touchscreen, according to various embodiments;

FIG. 2 is a schematic block diagram illustrating an apparatus for volume control swiping, according to various embodiments;

FIG. 3 is a schematic block diagram illustrating another apparatus for volume control swiping, according to various embodiments;

FIG. 4A is a schematic block diagram illustrating the computing device of FIG. 1 with a touchscreen oriented in a landscape mode, according to various embodiments;

FIG. 4B is a schematic block diagram illustrating the computing device of FIG. 1 with a touchscreen oriented in a portrait mode, according to various embodiments;

FIG. 5A is a schematic block diagram illustrating the computing device of FIG. 1 with a display of a first control screen for enabling volume control swiping, according to various embodiments;

FIG. 5B is a schematic block diagram illustrating the computing device of FIG. 1 with a display of a second control screen for enabling volume control swiping, according to various embodiments;

FIG. 6 is a schematic flow chart diagram illustrating a first method for volume control swiping, according to various embodiments;

FIG. 7 is a schematic flow chart diagram illustrating a second method for volume control swiping, according to various embodiments;

FIG. 8A is a first part of a schematic flow chart diagram illustrating a third method for volume control swiping, according to various embodiments; and

FIG. 8B is a second part of a schematic flow chart diagram illustrating the third method for volume control swiping, according to various embodiments.

### DETAILED DESCRIPTION

As will be appreciated by one skilled in the art, aspects of the embodiments may be embodied as a system, method or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices, in some embodiments, are tangible, non-transitory, and/or non-transmission.

Many of the functional units described in this specification have been labeled as modules, in order to more particularly emphasize their implementation independence. For example, a module may be implemented as a hardware circuit comprising custom very large scale integrated (“VLSI”) circuits or gate arrays, off-the-shelf semiconductors such as logic chips, transistors, or other discrete components. A module may also be implemented in programmable hardware devices such as a field programmable gate array (“FPGA”), programmable array logic, programmable logic devices or the like.

Modules may also be implemented in code and/or software for execution by various types of processors. An identified module of code may, for instance, comprise one or more physical or logical blocks of executable code which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be written in any combination of one or more programming languages including an object oriented programming language such as Python, Ruby, R, Java, Java Script, Smalltalk, C++, C sharp, Lisp, Clojure, PHP, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which comprises one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C.

A method for volume control swiping is disclosed. An apparatus and computer program product also perform the functions of the method. The method includes enabling volume control swiping for a landscape mode and/or a portrait mode of a touchscreen of a computing device. In response to detecting a speaker being active during execution of an application on the computing device, the method includes detecting swiping on the touchscreen in a landscape direction during operation of the computing device in the landscape mode and, in response to the volume control swiping being enabled for the landscape mode, adjusting a volume setting of the computing device in response to the detected swiping of the touchscreen in the landscape direction. Also, in response to detecting a speaker being active during execution of an application on the computing device, the method includes detecting swiping on the touchscreen in a portrait direction during operation of the computing device in the portrait mode, and in response to volume control swiping being enabled for the portrait mode, adjusting the volume setting of the computing device in response to the detected swiping of the touchscreen in the portrait direction.

In some embodiments, the detecting of the speaker of the computing device being active during execution of the application includes the detecting of the speaker of the computing device being active during execution of the application and/or detecting of a microphone of the computing device being active during the execution of the application. The detecting of the swiping on the touchscreen in the landscape direction and/or the portrait direction and subsequent adjusting the volume setting of the computing device are in response to the detecting of the speaker being active and/or the detection of the microphone being active. In other embodiments, enabling the volume control swiping for the landscape mode and/or the portrait mode and detecting the speaker being active and/or detecting the microphone being active disables at least a portion of touchscreen commands responsive to detected swiping the landscape direction and/or the portrait direction. In other embodiments, the method includes enabling volume control swiping on the computing device. The enabling of the volume control swiping for the landscape mode and/or the portrait mode is operable in response to the enabling of the volume control swiping.

In some embodiments, the detecting swiping on the touchscreen in the landscape direction during operation of the computing device in the landscape mode includes detecting swiping on the touchscreen in the landscape direction in a first landscape direction and the adjusting of the volume setting of the computing device in response to the detected swiping of the touchscreen in the landscape direction includes increasing the volume setting of the computing device in response to the detecting of the swiping in the first landscape direction. In other embodiments, the detecting swiping on the touchscreen in the landscape direction during operation of the computing device in the landscape mode includes detecting swiping on the touchscreen in the landscape direction in a second landscape direction opposite the first landscape direction and the adjusting of the volume setting of the computing device in response to the detected swiping of the touchscreen in the landscape direction includes decreasing the volume setting of the computing device in response to the detecting of the swiping in the second landscape direction.

In some embodiments, the detecting swiping on the touchscreen in the portrait direction during operation of the computing device in the portrait mode includes detecting swiping on the touchscreen in the portrait direction in a first portrait direction and the adjusting of the volume setting of the computing device in response to the detected swiping of the touchscreen in the portrait direction includes increasing the volume setting of the computing device in response to the detecting of the swiping in the first portrait direction. In other embodiments, the detecting swiping on the touchscreen in the portrait direction during operation of the computing device in the portrait mode includes detecting swiping on the touchscreen in the portrait direction in a second portrait direction opposite the first portrait direction and the adjusting of the volume setting of the computing device in response to the detected swiping of the touchscreen in the portrait direction includes decreasing the volume setting of the computing device in response to the detecting of the swiping in the second portrait direction.

In some embodiments, the detected swiping in the landscape direction and/or the detected swiping in the portrait direction exclude detecting swiping on a scroll bar displayed on the touchscreen, detecting swiping on an application control display on the touchscreen, and detecting swiping on an edge of the touchscreen designated for control of the computing device. In other embodiments, in response to the volume control swiping being enabled for the landscape mode and disabled for the portrait mode and operation of the touchscreen in the portrait mode, detecting swiping on the touchscreen in the landscape direction results in no change to the volume. In other embodiments, in response to the volume control swiping being enabled for the portrait mode and disabled for the landscape mode and operation of the touchscreen in the landscape mode, detecting swiping on the touchscreen in the portrait direction results in no change to the volume.

An apparatus for volume control swiping includes a processor and non-transitory computer readable storage media storing code. The code is executable by the processor to perform operations that include enabling volume control swiping for a landscape mode and/or a portrait mode of a touchscreen of a computing device, and in response to detecting a speaker being active during execution of an application on the computing device, the operations include detecting swiping on the touchscreen in a landscape direction during operation of the computing device in the landscape mode, and, in response to the volume control swiping being enabled for the landscape mode, adjusting a volume setting of the computing device in response to the detected swiping of the touchscreen in the landscape direction. Also in response to detecting a speaker being active during execution of an application on the computing device, the operations include detecting swiping on the touchscreen in a portrait direction during operation of the computing device in the portrait mode and, in response to volume control swiping being enabled for the portrait mode, adjusting the volume setting of the computing device in response to the detected swiping of the touchscreen in the portrait direction.

In some embodiments, the detecting of the speaker of the computing device being active during the execution of the application includes the detecting of the speaker of the computing device being active during the execution of the application and/or detecting of a microphone of the computing device being active during the execution of the application, and the detecting of the swiping on the touchscreen in the landscape direction and/or the portrait direction and subsequent adjusting the volume setting of the computing device are in response to the detecting of the speaker being active and/or the detection of the microphone being active. In other embodiments, enabling the volume control swiping for the landscape mode and/or the portrait mode and detecting the speaker being active and/or detecting the microphone being active disables at least a portion of touchscreen commands responsive to detected swiping the landscape direction and/or the portrait direction. In other embodiments, the operations include enabling volume control swiping on the computing device. The enabling of the volume control swiping for the landscape mode and/or the portrait mode is operable in response to the enabling of the volume control swiping.

In some embodiments, the detecting swiping on the touchscreen in the landscape direction during operation of the computing device in the landscape mode includes detecting swiping on the touchscreen in the landscape direction in a first landscape direction and the adjusting of the volume setting of the computing device in response to the detected swiping of the touchscreen in the landscape direction includes increasing the volume setting of the computing device in response to the detecting of the swiping in the first landscape direction. In other embodiments, the detecting swiping on the touchscreen in the landscape direction during operation of the computing device in the landscape mode includes detecting swiping on the touchscreen in the landscape direction in a second landscape direction opposite the first landscape direction and the adjusting of the volume setting of the computing device in response to the detected swiping of the touchscreen in the landscape direction includes decreasing the volume setting of the computing device in response to the detecting of the swiping in the second landscape direction.

In some embodiments, the detecting swiping on the touchscreen in the portrait direction during operation of the computing device in the portrait mode includes detecting swiping on the touchscreen in the portrait direction in a first portrait direction and the adjusting of the volume setting of the computing device in response to the detected swiping of the touchscreen in the portrait direction includes increasing the volume setting of the computing device in response to the detecting of the swiping in the first portrait direction. In other embodiments, the detecting swiping on the touchscreen in the portrait direction during operation of the computing device in the portrait mode includes detecting swiping on the touchscreen in the portrait direction in a second portrait direction opposite the first portrait direction and the adjusting of the volume setting of the computing device in response to the detected swiping of the touchscreen in the portrait direction includes decreasing the volume setting of the computing device in response to the detecting of the swiping in the second portrait direction.

In some embodiments, the detected swiping in the landscape direction and/or the detected swiping in the portrait direction exclude detecting swiping on a scroll bar displayed on the touchscreen, detecting swiping on an application control display on the touchscreen, and detecting swiping on an edge of the touchscreen designated for control of the computing device. In other embodiments, in response to the volume control swiping being enabled for the landscape mode and disabled for the portrait mode and operation of the touchscreen in the portrait mode, detecting swiping on the touchscreen in the landscape direction results in no change to the volume. In other embodiments, in response to the volume control swiping being enabled for the portrait mode and disabled for the landscape mode and operation of the touchscreen in the landscape mode, detecting swiping on the touchscreen in the portrait direction results in no change to the volume.

A program product for volume control swiping includes a non-transitory computer readable storage medium storing code. The code is configured to be executable by a processor to perform operations that include enabling volume control swiping for a landscape mode and/or a portrait mode of a touchscreen of a computing device. In response to detecting a speaker being active during execution of an application on the computing device, the operations include detecting swiping on the touchscreen in a landscape direction during operation of the computing device in the landscape mode, and in response to the volume control swiping being enabled for the landscape mode, adjusting a volume setting of the computing device in response to the detected swiping of the touchscreen in the landscape direction. Also, in response to detecting a speaker being active during execution of an application on the computing device, the operations include detecting swiping on the touchscreen in a portrait direction during operation of the computing device in the portrait mode, and in response to volume control swiping being enabled for the portrait mode, adjusting the volume setting of the computing device in response to the detected swiping of the touchscreen in the portrait direction.

In some embodiments, the detecting of the speaker of the computing device being active during the execution of the application includes the detecting of the speaker of the computing device being active during the execution of the application and/or detecting of a microphone of the computing device being active during the execution of the application, and the detecting of the swiping on the touchscreen in the landscape direction and/or the portrait direction and subsequent adjusting the volume setting of the computing device are in response to the detecting of the speaker being active and/or the detection of the microphone being active. In other embodiments, the operations include enabling volume control swiping on the computing device. The enabling of the volume control swiping for the landscape mode and/or the portrait mode is operable in response to the enabling of the volume control swiping.

In some embodiments, the detecting swiping on the touchscreen in the landscape direction during operation of the computing device in the landscape mode includes detecting swiping on the touchscreen in the landscape direction in a first landscape direction and the adjusting of the volume setting of the computing device in response to the detected swiping of the touchscreen in the landscape direction includes increasing the volume setting of the computing device in response to the detecting of the swiping in the first landscape direction. In other embodiments, the detecting swiping on the touchscreen in the landscape direction during operation of the computing device in the landscape mode includes detecting swiping on the touchscreen in the landscape direction in a second landscape direction opposite the first landscape direction and the adjusting of the volume setting of the computing device in response to the detected swiping of the touchscreen in the landscape direction includes decreasing the volume setting of the computing device in response to the detecting of the swiping in the second landscape direction.

In other embodiments, the detecting swiping on the touchscreen in the portrait direction during operation of the computing device in the portrait mode includes detecting swiping on the touchscreen in the portrait direction in a first portrait direction and the adjusting of the volume setting of the computing device in response to the detected swiping of the touchscreen in the portrait direction includes increasing the volume setting of the computing device in response to the detecting of the swiping in the first portrait direction. In other embodiments, the detecting swiping on the touchscreen in the portrait direction during operation of the computing device in the portrait mode includes detecting swiping on the touchscreen in the portrait direction in a second portrait direction opposite the first portrait direction and the adjusting of the volume setting of the computing device in response to the detected swiping of the touchscreen in the portrait direction includes decreasing the volume setting of the computing device in response to the detecting of the swiping in the second portrait direction.

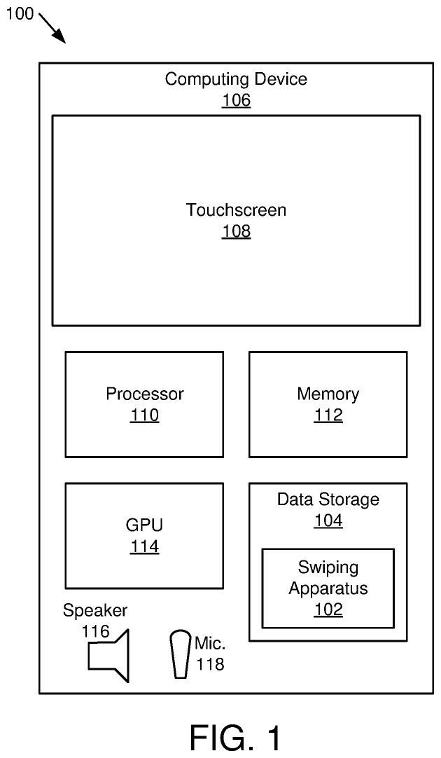

FIG. 1 is a schematic block diagram 100 illustrating a swiping apparatus 102 for volume control swiping in a computing device 106 with a touchscreen 108, according to various embodiments. The computing device 106 includes data storage 104 with the swiping apparatus 102. In some embodiments, the data storage 104 is non-volatile data storage, and may be called computer readable storage media, which is non-transitory. The data storage 104 may include a hard disk drive, solid-state storage, an optical drive, or the like.

The computing device 106 may be a smartphone, a tablet, a controller for an audio system, a laptop computer, an all-in-one desktop computer, an appliance with a touchscreen 108, or other computing device with a touchscreen 108. In some embodiments (not shown), the touchscreen 108 is separate from the computing device 106, such as an electronic display with a touchscreen 108 where the computing device 106 is a desktop computer, a workstation, or other computer connected to a separate electronic display with a touchscreen 108. One of skill in the art will recognize other computing devices 106 with a touchscreen 108 where volume control swiping is useful.

The computing device 106 includes a processor 110 and memory 112 where the processor 110 is capable of executing code of the swiping apparatus 102. Typically, the processor 110 loads some or all of the code for the swiping apparatus 102 into the memory 112 for execution. In some embodiments, the processor 110 is a central processing unit (“CPU”) and may include multiple cores. In some embodiments, the memory 112 is volatile memory, such as cache, random access memory (“RAM”), or the like.

In some embodiments, the computing device 106 includes a graphical processing unit (“GPU”) 114, which is typically used for processing data to be displayed on the touchscreen 108 and/or processing touch signals from the touchscreen 108. The computing device 106 includes one or more speakers 116 and at least one microphone 118. The swiping apparatus 102, in various embodiments, controls volume of the speaker(s) 116 and/or the microphone 118. In some embodiments, the one or more speakers 116 are built into the computing device 106. In other embodiments, the speakers 116 are external to the computing device 106 and are controlled by signals from the computing device 106, which may be wired or wireless. The swiping apparatus 102 controls volume of the signals to the speakers 116 when the swiping apparatus 102 is active. In some embodiments, the swiping apparatus 102 controls volume to the microphone 118 when active.

The swiping apparatus 102 is configured to increase and decrease a volume setting of the computing device 106 in response to various swiping motions on the touchscreen 108. When volume control swiping is enabled and the speakers 116 are active and when the touchscreen 108 is in a landscape mode, swiping on the touchscreen 108 in a landscape direction increases and/or decreases the volume setting on the computing device 106, which increases or decreases volume on the speaker 116. In some embodiments, the swiping apparatus 102 monitors operation of the speaker(s) 116 and the microphone 118 of the computing device 106 and when the speaker(s) 116 are active, the microphone 118 is active, or both are active, the swiping apparatus 102 increases or decreases the volume setting on the computing device 106 which may affect volume on the speaker(s) 116, may affect volume on the microphone 118, or both. The swiping apparatus 102 is described in detail below.

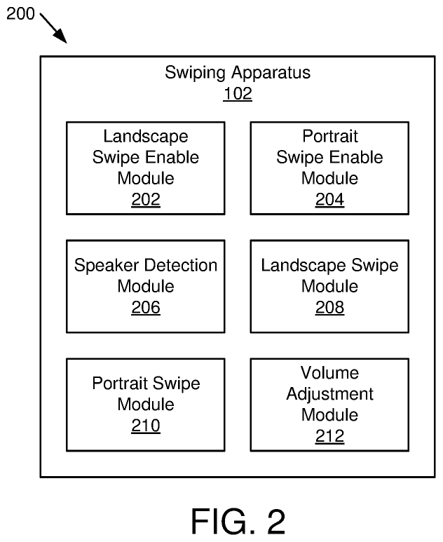

FIG. 2 is a schematic block diagram illustrating an apparatus 200 for volume control swiping, according to various embodiments. The apparatus 200 includes a swiping apparatus 102 with a landscape swipe enable module 202, a portrait swipe enable module 204, a speaker detection module 206, a landscape swipe module 208, a portrait swipe module 210, and a volume adjustment module 212, which are described below. In some embodiments, the apparatus 200 is implemented with executable code stored on a computer readable storage device. In the embodiments, the apparatus 200 interacts with the processor 110, which interacts with hardware and software of the computing device 106 to adjust volume. In other embodiments, all or a portion of the apparatus 200 is implemented on a programmable hardware device. In some embodiments, all or a portion of the apparatus 200 is implemented using hardware circuits.

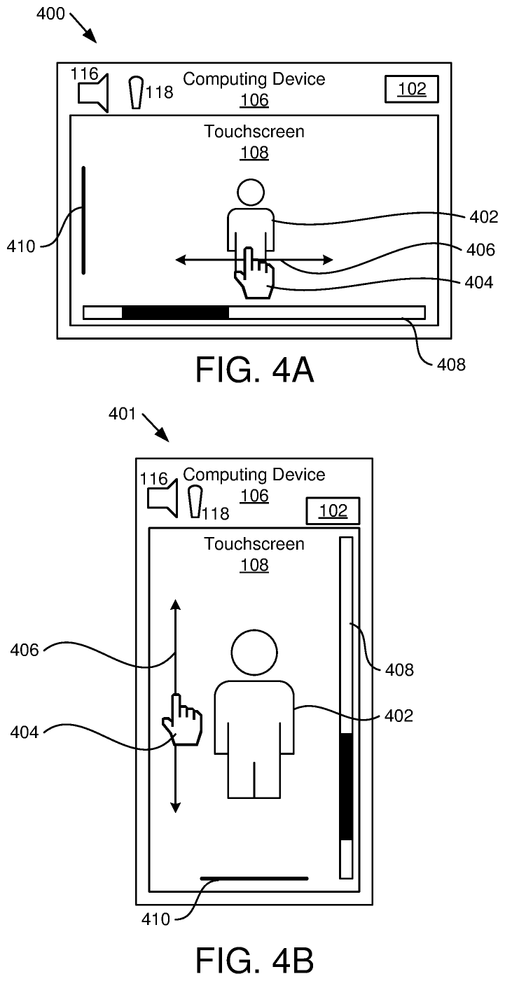

The apparatus 200 includes a landscape swipe enable module 202 configured to enable volume control swiping for landscape mode of the touchscreen 108 of the computing device 106 and a portrait swipe enable module 204 configured to enable volume control swiping for portrait mode of the touchscreen 108 of the computing device 106. Landscape mode, as used herein, is a display of material on the touchscreen 108 such that a horizontal dimension of the display is larger than a vertical dimension of the display. Portrait mode, as used herein, is a display of material on the touchscreen 108 such that a vertical dimension of the display is larger than a horizontal dimension of the display. Thus, if a person is displayed on the touchscreen in portrait mode, the head of the person will be towards a narrow side of the touchscreen 108. If the person is displayed on the touchscreen in landscape mode, the head of the person will towards a wide side of the touchscreen 108. FIG. 4A depicts the computing device 106 where the touchscreen 108 is in a landscape mode if material on the display, such as a person 402, is oriented with a top towards the wide dimension of the touchscreen 108, as shown in FIG. 4A. FIG. 4B depicts the computing device 106 where the touchscreen 108 is in portrait mode so that material, such as a person 402, on the touchscreen 108 is oriented with a top towards the narrow portion of the touchscreen 108, as shown in FIG. 4B.

Landscape mode and portrait mode, as described herein, are with respect to material displayed on the touchscreen 108 and may or may not depend on physical orientation of the touchscreen 108. In some embodiments, the computing device 106 changes from portrait mode to landscape mode and from landscape mode to portrait mode by rotating the computing device 106 and touchscreen 108. In other embodiments, the computing device 106 includes a setting that locks the touchscreen 108 in portrait mode or landscape mode. In other embodiments, the computing device 106 includes a control that switches between portrait mode and landscape mode.

In some embodiments, the landscape swipe enable module 202 includes a control button, slide, toggle, etc. that allows a user to enable volume control swiping for landscape mode. In other embodiments, the portrait swipe enable module 204 includes a control button, slide, toggle, etc. that allows a user to enable volume control swiping for portrait mode. In some embodiments, the landscape swipe enable module 202 and the portrait swipe enable module 204 allow enabling both volume control swiping for portrait mode and allow volume control swiping for landscape mode.

The apparatus 200 includes a speaker detection module 206 configured to detect the speaker 116 being active during execution of an application on the computing device 106. In some embodiments, the speaker detection module 206 detects the speaker 116 being active by detecting a sound signal being sent to the speaker 116, detecting a voltage on a signal line to the speaker 116, detecting that the application has a soundtrack, or other method known to those of skill in the art. In some embodiments, the landscape swipe enable module 202 and the portrait swipe enable module 204 allow volume control swiping in response to the speaker detection module 206 detecting that the speaker 116 is active.

The apparatus 200 includes a landscape swipe module 208 configured to detect swiping on the touchscreen 108 in a landscape direction during operation of the computing device 106 in the landscape mode. In some embodiments, the landscape swipe module 208 detects that the computing device 106 is operating in landscape mode by interacting with touchscreen controls and commands and accessing a variable, a signal, etc. that is indicative of the touchscreen 108 of the computing device 106 being commanded to operate in the landscape mode.

The apparatus 200 includes a portrait swipe module 210 configured to detect swiping on the touchscreen 108 in a portrait direction during operation of the computing device 106 in the portrait mode. In some embodiments, the portrait swipe module 210 detects that the computing device 106 is operating in portrait mode by interacting with touchscreen controls and commands and accessing a variable, a signal, etc. that is indicative of the touchscreen 108 of the computing device 106 being commanded to operate in the portrait mode.

In some embodiments, the landscape swipe module 208 detects swiping on the touchscreen 108 by monitoring input from the touchscreen 108 and determining that the input from the touchscreen 108 includes a swiping motion in the landscape direction. As used herein, swiping in the landscape direction (“landscape swipe”) is movement of a finger, a stylus, etc. on the touchscreen 108 in a horizontal direction along a wide dimension of the touchscreen 108 when the touchscreen 108 is in the landscape mode. In some embodiments, the portrait swipe module 210 detects swiping on the touchscreen 108 by monitoring input from the touchscreen 108 and determining that the input from the touchscreen 108 includes a swiping motion in the portrait direction. As used herein, swiping in the portrait direction is movement of a finger, a stylus, etc. on the touchscreen 108 in a vertical direction, which is in a direction along the wide dimension of the touchscreen 108 while the touchscreen 108 is in portrait mode.

FIG. 4A depicts swiping in the landscape direction as the hand 404 moves horizontally, as depicted by the arrow 406 under the hand 404. FIG. 4B depicts swiping in the portrait direction as the hand 404 moves vertically, as depicted by the arrow 406 under the hand 404. In some embodiments, swiping input on the touchscreen 108 includes movement of something (finger, pen, stylus, etc.) on the touchscreen 108 with some unwanted component, such as a vertical component while the landscape swipe module 208 is detecting a landscape swipe or a horizontal component while the portrait swipe module 210 is detecting a portrait swipe. In other embodiments, swiping input may include some shape not considered a swipe, such as a movement on the touchscreen 108 with a curvature. The landscape swipe module 208, in some embodiments, detects a swipe in the landscape direction, which is to be used for volume control, as a substantially straight line that is horizontal or angled with respect to horizontal no more than a specified landscape angle, such as less than 30 degrees. In other embodiments, the specified landscape angle is more or less than 30 degrees. The portrait swipe module 210, in some embodiments, detects a swipe in the portrait direction, which is to be used for volume control, as a substantially straight line that is vertical or angled with respect to vertical no more than a specified portrait angle, such as less than 30 degrees. In other embodiments, the specified portrait angle is more or less than 30 degrees.

In some embodiments, the landscape swipe module 208 determines if movement on the touchscreen 108 qualifies as a landscape swipe and the portrait swipe module 210 determines if movement on the touchscreen 108 qualifies as a portrait swipe by detecting an amount of curvature of the movement and determines that the movement is a swipe if curvature is less than a prescribed amount of curvature. For example, a small amount of curvature below a particular angle may be considered a landscape swipe or portrait swipe and curvature above the particular angle is not considered a landscape swipe or a portrait swipe. In other embodiments, the landscape swipe module 208 and the portrait swipe module 210 eliminate swiping as a landscape swipe and portrait swipe using other criteria, such as stopping and starting during a swipe, change of direction during a swipe, etc.

In some embodiments, the landscape swipe module 208 detects a direction of a landscape swipe. In some embodiments, the portrait swipe module 210 detects a direction of a portrait swipe. The direction of the landscape swipe or vertical swipe, in some embodiments, determines whether the volume setting is to be raised or lowered. In some embodiments, a right-to-left landscape swipe signals a volume increase and a left-to-right landscape swipe signals a volume decrease. In other embodiments, a bottom-to-top portrait swipe signals a volume increase and a top-to-bottom portrait swipe signals a volume decrease. In other embodiments, the directions of the swipes may be reversed for volume increasing and decreasing. In other embodiments, increasing or decreasing volume is based on different directions of swiping.

In other embodiments, the landscape swipe module 208 and the portrait swipe module 210 detect a distance of a swipe. The distance of the landscape swipe or portrait swipe, in some embodiments, corresponds to an amount of raising or lowering the volume setting. In other embodiments, a short landscape swipe or portrait swipe indicates a small amount of volume change and a long landscape swipe or portrait swipe indicates a large amount of volume change.

In some embodiments, the landscape swipe module 208 and the portrait swipe module 210 each detect where a landscape swipe or portrait swipe occurs on the touchscreen 108. In some embodiments, the touchscreen 108 includes a scrollbar 408, an application control display, an edge of the touchscreen 108 designated for control of applications, widgets, etc. In some examples, the computing device 106 includes a bar 410 or other indicator at an edge of touchscreen 108, as depicted in FIGS. 4A and 4B, where swiping from that position ends an application, causes the application to run in a background, enables choice of another application, etc., as is common on a iPhone® by Apple®.

In other embodiments swiping from a top edge of a touchscreen 108 brings down a menu, a group of widgets, a display of notifications, or the like. In such embodiments, the landscape swipe module 208 detects a landscape swipe and the portrait swipe module 210 detects a portrait swipe when the swipe occurs away from the scrollbar 408, application control area, edge designated for control of applications, functions, etc. and other areas on a touchscreen 108 not to be overridden by a swipe intended for volume control. In such embodiments, swipes on the scrollbar 408, edges, etc. trigger other actions by the computing device 106 while the landscape swipe module 208 and the portrait swipe module 210 ignore such swipes. In some embodiments, the landscape swipe module 208 and the portrait swipe module 210 accept swipes in a particular area on the touchscreen 108, which may be a center section, a narrow band along a side, or the like.

The apparatus 200 includes a volume adjustment module 212 configured to adjust the volume setting of the computing device 106 in response to the volume control swiping being enabled for the landscape mode by the landscape swipe enable module 202 and in response to the landscape swipe module 208 detecting a swipe in the landscape direction on the touchscreen 108. The volume adjustment module 212 is also configured to adjust the volume setting of the computing device 106 in response to the volume control swiping being enabled for the portrait mode by the portrait swipe enable module 204 and in response to the portrait swipe module 210 detecting a swipe in the portrait direction on the touchscreen 108. In some embodiments, the landscape swipe module 208 and the portrait swipe module 210 relay to the volume adjustment module 212 an amount to adjust the volume setting based on a length of a landscape swipe or a portrait swipe. In other embodiments, the volume adjust module 212 adjusts volume differently based on a speed of a swipe.

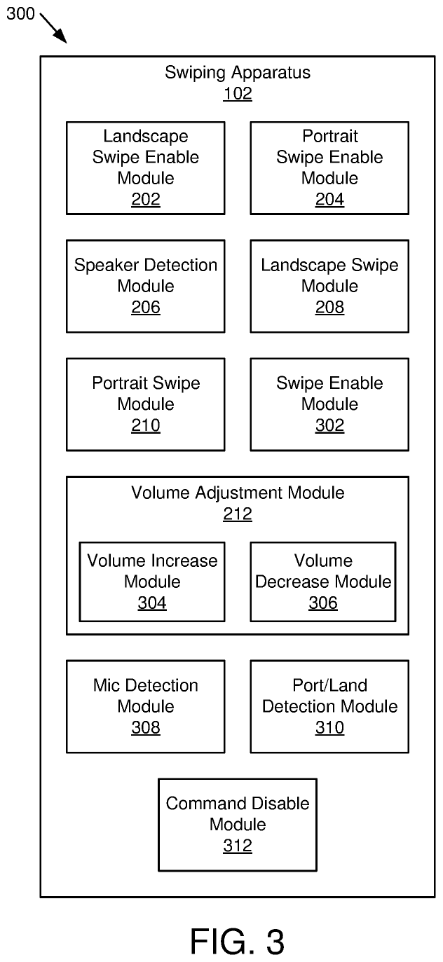

FIG. 3 is a schematic block diagram illustrating another apparatus 300 for volume control swiping, according to various embodiments. The apparatus 300 includes another swiping apparatus 102 with a landscape swipe enable module 202, a portrait swipe enable module 204, a speaker detection module 206, a landscape swipe module 208, a portrait swipe module 210, and a volume adjustment module 212, which are substantially similar to those described above in relation to the apparatus 200 of FIG. 2. In various embodiments, the apparatus 300 includes a swipe enable module 302, a microphone detection module 308, a portrait/landscape detection module 310, a command disable module 312, and/or the volume adjustment module 212 includes a volume increase module 304 and/or a volume decrease module 306, which are described below. In some embodiments, the apparatus 300 is implemented with executable code stored on a computer readable storage device. In the embodiments, the apparatus 300 interacts with the processor 110, which interacts with hardware and software of the computing device 106 to adjust volume. In other embodiments, all or a portion of the apparatus 300 is implemented on a programmable hardware device. In some embodiments, all or a portion of the apparatus 300 is implemented using hardware circuits.

In some embodiments, the apparatus 300 includes a swipe enable module 302 configured to enable volume control swiping on the computing device 106. The enabling of the volume control swiping for the landscape mode and/or the portrait mode is operable in response to the enabling of the volume control swiping by the swipe enable module 302. The swipe enable module 302 acts as an overall enabling control for swiping to control volume when the speaker 116 and/or the microphone 118 are active. In some embodiments, the swipe enable module 302 is responsive to user input where the user input causes the swipe enable module 302 to enable the volume control swiping. In some embodiments, the swipe enable module 302 presents a toggle button, a slide button, or the like on a controls screen.

In some embodiments, the volume adjustment module 212 includes a volume increase module 304 and/or a volume decrease module 306. When the landscape swipe module 208 detects swiping on the touchscreen 108 in a first landscape direction during operation of the computing device 106 in the landscape mode, the volume increase module 304 is configured to increase the volume setting of the computing device 106. When the landscape swipe module 208 detects swiping on the touchscreen 108 in a second landscape direction opposite the first landscape direction during operation of the computing device 106 in the landscape mode, the volume decrease module 306 is configured to decrease the volume setting of the computing device 106. When the portrait swipe module 210 detects swiping on the touchscreen 108 in a first portrait direction during operation of the computing device 106 in the portrait mode, the volume increase module 304 is configured to increase the volume setting of the computing device 106. When the portrait swipe module 210 detects swiping on the touchscreen 108 in a second portrait direction opposite the first portrait direction during operation of the computing device 106 in the portrait mode, the volume decrease module 306 is configured to decrease the volume setting of the computing device 106. As used herein, volume is a measurement of loudness of the speaker(s) 116 and/or microphone 118.

In some embodiments, the apparatus 300 includes a microphone detection module 308 configured to detect that the microphone 118 is active during execution of an application. The apparatus 300 then uses both the speaker detection module 206 and the microphone detection module 308 to detect if one or more speakers 116 are active, if the microphone 118 is active, or both as a condition to allow volume control swiping. In some embodiments, the microphone detection module 308 detects if the microphone 118 is active if the microphone 118 has power. In other embodiments, the microphone detection module 308 detects if the microphone 118 is active by detecting input from the microphone 118. One of skill in the art will recognize other ways for the microphone detection module 308 to detect if the microphone 118 of the computing device 106 is active.

In some embodiments, the apparatus 300 includes portrait/landscape detection module 310 configured to detect if the touchscreen 108 is operating in the portrait mode or the landscape mode. In some embodiments, the portrait/landscape detection module 310 interacts with an operating system and/or GPU 114 of the computing device 106 to detect if the touchscreen 108 is operating in the portrait mode or landscape mode. In other embodiments, the portrait/landscape detection module 310 uses data from one or more sensors in the computing device 106 that detect orientation of the touchscreen 108 to detect portrait mode or landscape mode.

The apparatus 300 includes, in some embodiments, a command disable module 312 configured to disable at least a portion of touchscreen commands responsive to detected swiping the landscape direction and/or the portrait direction when volume control swiping is enabled for landscape mode and/or portrait module and the speaker detection module 206 detecting the speaker 116 being active and/or the microphone detection module 308 detecting the microphone 118 being active. For example, where swiping on the touchscreen 108 results in scrolling, in some embodiments, the command disable module 312 disables the scrolling when volume control swiping is active and the speaker 116 and/or the microphone 118 are active. In other embodiments, the command disable module 312 re-enables the disabled touchscreen commands when the speaker 116 and the microphone 118 are not active or if volume control swiping is disabled. In some embodiments, the command disable module 312 disables touchscreen commands in a certain region of the touchscreen 108, such as in a region interior to a scrollbar 408, a bar 410 or other location at an edge of the touchscreen 108 for commands still intended to be active while volume control swiping is still active.

FIG. 4A is a schematic block diagram 400 illustrating the computing device 106 of FIG. 1 with a touchscreen 108 oriented in a landscape mode, according to various embodiments. The computing device 106 includes the swiping apparatus 102, the touchscreen 108, the speaker 116, and the microphone 118 as depicted in FIG. 1. The touchscreen 108 includes a scrollbar 408 and a bar 410 similar to a bar on an iPhone® where swiping for volume control is not detected by the landscape swipe module 208 and the portrait swipe module 210. FIG. 4A depicts a person 402 being displayed on the touchscreen 108 where the orientation of the person 402 is intended to be indicative of the touchscreen 108 operating in landscape mode so that material displayed on the touchscreen 108 is presented in the landscape orientation. FIG. 4A depicts a hand 404, which represents a hand, finger, etc. of a user swiping on the touchscreen 108 and the arrow 406 indicates a direction of the swiping being horizontal, which is the landscape direction of swiping. In some embodiments, swiping horizontally from left to right initiates an increase in a volume setting of the computing device 106 while swiping horizontally from right to left initiates a decrease in the volume setting. In other embodiments, swiping horizontally from left to right initiates a decrease in a volume setting of the computing device 106 while swiping horizontally from right to left initiates an increase in the volume setting.

FIG. 4B is a schematic block diagram 401 illustrating the computing device 106 of FIG. 1 with a touchscreen 108 oriented in a portrait mode, according to various embodiments. FIG. 4B includes the swiping apparatus 102, the touchscreen 108, the speaker 116, and the microphone 118 of the computing device 106 of FIG. 1 and the touchscreen 108 depicts a scrollbar 408 and bar 410. The touchscreen 108 is oriented in portrait mode so that a long dimension of the touchscreen 108 is oriented vertically and a person 402 depicted on the touchscreen 108 is oriented vertically in the portrait mode with a head towards the top of the computing device 106 representing material displayed on the touchscreen 108 in a portrait orientation. A hand 404 representing a user's finger, hand, etc. is swiping vertically, as indicated by the arrow 406. In some embodiments, swiping vertically from bottom to top initiates an increase in a volume setting of the computing device 106 while swiping vertically from top to bottom initiates a decrease in the volume setting. In other embodiments, swiping vertically from bottom to top initiates a decrease in a volume setting of the computing device 106 while swiping vertically from top to bottom initiates an increase in the volume setting.

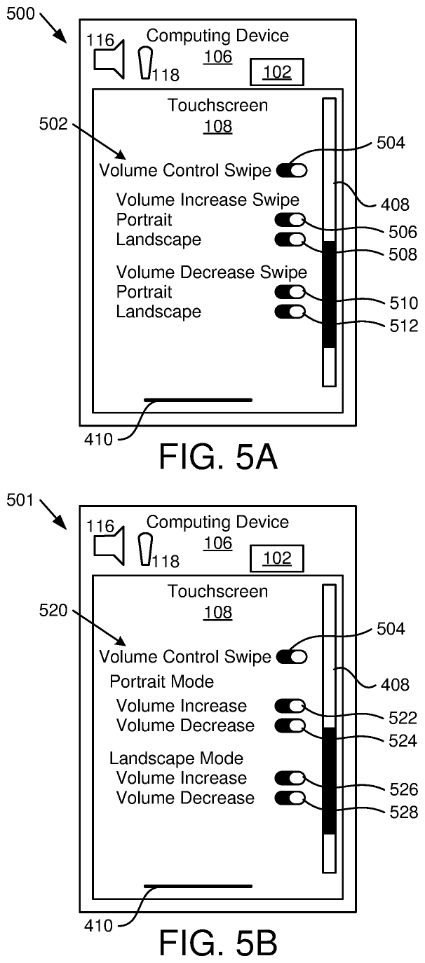

FIG. 5A is a schematic block diagram 500 illustrating the computing device 106 of FIG. 1 with a display of a first control screen 502 for enabling volume control swiping, according to various embodiments. The first control screen 502 includes volume control swipe enable slide 504 intended to enable volume control swiping overall. For volume increase swiping control, a portrait slide 506 is intended to enable volume increase swiping in portrait mode and a landscape slide 508 is intended to enable volume increase swiping in landscape mode. For volume decrease swiping control, a portrait slide 510 is intended to enable volume decrease swiping in portrait mode and a landscape slide 512 is intended to enable volume decrease swiping in landscape mode.

FIG. 5B is a schematic block diagram 501 illustrating the computing device 106 of FIG. 1 with a display of a second control screen 520 for enabling volume control swiping, according to various embodiments. The second control screen 520 includes volume control swipe enable slide 504 intended to enable volume control swiping overall, similar to the volume control swipe enable slide 504 of FIG. 5A. The second control screen 520 includes two controls for portrait mode: a volume increase slide 522 and a volume decrease slide 524. The second control screen 520 includes two controls for landscape mode: a volume increase slide 526 and a volume decrease slide 528.

Other control screens may also be used, such as a control screen with a volume control swipe enable slide 504 along with a portrait mode swiping slide that enables both increasing and decreasing for volume control swiping in portrait mode and a landscape mode swiping slide that enables both increasing and decreasing for volume control swiping in landscape mode. In other embodiments, the control screens 500, 501 includes controls other than slides, such as buttons, toggles, etc. One of skill in the art will recognize other control screens and options for volume control swiping controls.

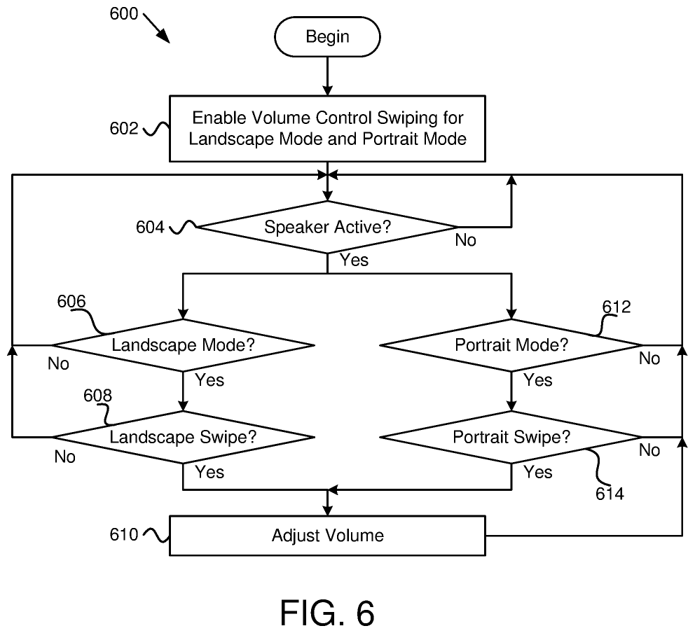

FIG. 6 is a schematic flow chart diagram illustrating a first method 600 for volume control swiping, according to various embodiments. The method 600 begins and enables 602 volume control swiping for a landscape mode and/or a portrait mode of a touchscreen 108 of a computing device 106. The method 600 detects 604 whether the speaker 116 is active. If the method 600 detects 604 that the speaker 116 is not active, the method 600 returns and continues to detect 604 whether the speaker 116 is active. If the method 600 detects 604 that the speaker 116 is active, the method 600 determines 606 if volume control swiping is enabled for landscape mode. If the method 600 determines 606 that the volume control swiping is not enabled for landscape mode, the method 600 returns and continues to detect 604 if the speaker 116 is active.

If the method 600 determines 606 that the volume control swiping is enabled for landscape mode, the method 600 detects 608 swiping on the touchscreen 108 in the landscape direction, which is horizontal in some embodiments, during operation of the computing device 106 in landscape mode. If the method 600 does not detect 608 horizontal swiping, the method 600 returns and continues to detect 604 if the speaker 116 is active. If the method 600 detects 608 horizontal swiping, the method 600 adjusts 610 a volume setting of the computing device 106 and returns and continues to detect 604 if the speaker 116 is active.

If the method 600 detects 604 that the speaker 116 is active, the method 600 also determines 612 if volume control swiping is enabled for the portrait mode. If the method 600 determines 612 that volume control swiping is not enabled for the portrait mode, the method 600 returns and continues to detect 604 if the speaker 116 is active. If the method 600 determines 612 that volume control swiping is enabled for the portrait mode, the method 600 detects 614 if swiping on the touchscreen 108 in the portrait direction, which is vertical in some embodiments, during operation of the computing device 106 in portrait mode. If the method 600 does not detect 614 swiping in the portrait direction, the method 600 returns and continues to detect 604 if the speaker 116 is active. If the method 600 detects 614 swiping in the portrait direction, the method 600 adjusts the volume setting of the computing device 106 and returns and continues to detect 604 if the speaker 116 is active. In various embodiments, all or a portion of the method 600 is implemented using the landscape swipe enable module 202, the portrait swipe enable module 204, the speaker detection module 206, the landscape swipe module 208, the portrait swipe module 210, and/or the volume adjustment module 212.

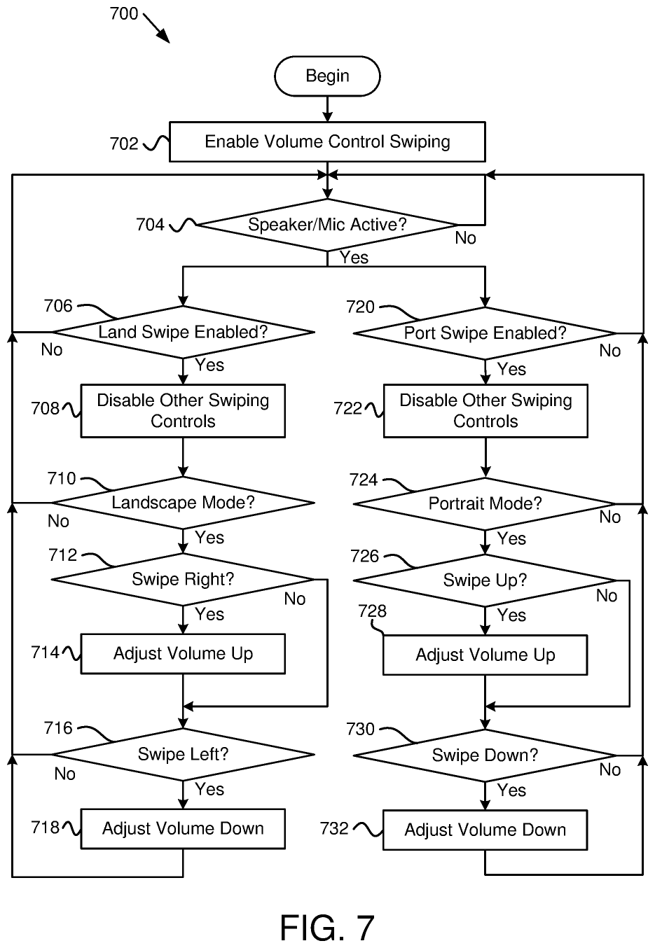

FIG. 7 is a schematic flow chart diagram illustrating a second method 700 for volume control swiping, according to various embodiments. The method 700 begins and enables 702 volume control swiping for a touchscreen 108 of a computing device 106 and detects 704 whether the speaker 116 and/or microphone 118 are active. If the method 700 detects 704 that either of the speaker 116 or microphone 118 are active, the method 700 determines 706 if landscape volume control swiping is enabled. If the method 700 determines 706 that the landscape volume control swiping is not enabled, the method 700 returns and continues to detect 704 if the speaker 116 and/or microphone 118 are active. If the method 700 determines 706 that the landscape volume control swiping is enabled, the method 700 disables 708 other swiping controls on a portion of the touchscreen 108 used for volume control swiping and determines 710 if the touchscreen 108 is in landscape mode.

If the method 700 determines 710 that the touchscreen 108 is not in landscape mode, the method 700 returns and continues to detect 704 if the speaker 116 and/or microphone 118 are active. If the method 700 determines 710 that the landscape mode is active on the computing device 106, the method 700 detects 712 if swiping on the touchscreen 108 is in a first landscape direction, such as right to left. If the method 700 detects 712 swiping on the touchscreen 108 is in the first landscape direction, the method 700 adjusts 714 up a volume setting on the computing device 106 and detects 716 if swiping on the touchscreen 108 is in a second landscape direction, such as from right to left. If the method 700 detects 716 swiping on the touchscreen 108 is in the second landscape direction, the method 700 adjusts 718 down the volume setting of the computing device 106 and returns and continues to detect 704 if the speaker 116 and/or microphone 118 are active. If the method 700 does not detect 712 swiping in the first landscape direction, the method 700 detects 716 if there is swiping in the second landscape direction.

If the method 700 detects 704 that the speaker 116 is active or the microphone 118 is active or both, the method 700 also determines 720 if portrait volume control swiping is enabled. If the method 700 determines 720 that portrait volume control swiping is not enabled, the method 700 returns and continues to detect 704 if the speaker 116 and/or microphone 118 are active. If the method 700 determines 720 that portrait volume control swiping is enabled, the method 700 disables 722 other swiping controls on a portion of the touchscreen 108 used for volume control swiping and determines 724 if the touchscreen 108 is in portrait mode.

If the method 700 determines 724 that the touchscreen 108 is not in portrait mode, the method 700 returns and continues to detect 704 if the speaker 116 and/or microphone 118 are active. If the method 700 determines 724 that the portrait mode is active on the computing device 106, the method 700 detects 726 if swiping on the touchscreen 108 is in a first portrait direction, such as up in a direction from bottom to top. If the method 700 detects 726 swiping on the touchscreen 108 is in the first portrait direction, the method 700 adjusts 728 up a volume setting on the computing device 106 and detects 730 if swiping on the touchscreen 108 is in a second portrait direction, such as down in a direction from top to bottom. If the method 700 detects 730 swiping on the touchscreen 108 in the second portrait direction, the method 700 adjusts 732 down the volume setting of the computing device 106 and returns and continues to detect 704 if the speaker 116 and/or microphone 118 are active. If the method 700 does not detect 726 swiping in the first portrait direction, the method 700 detects 730 if there is swiping in the second portrait direction.

In various embodiments, all or a portion of the method 700 is implemented using the landscape swipe enable module 202, the portrait swipe enable module 204, the speaker detection module 206, the landscape swipe module 208, the portrait swipe module 210, the volume adjustment module 212, swipe enable module 302, the volume increase module 304, the volume decrease module 306, the microphone detection module 308, the portrait/landscape detection module 310, and/or the command disable module 312.

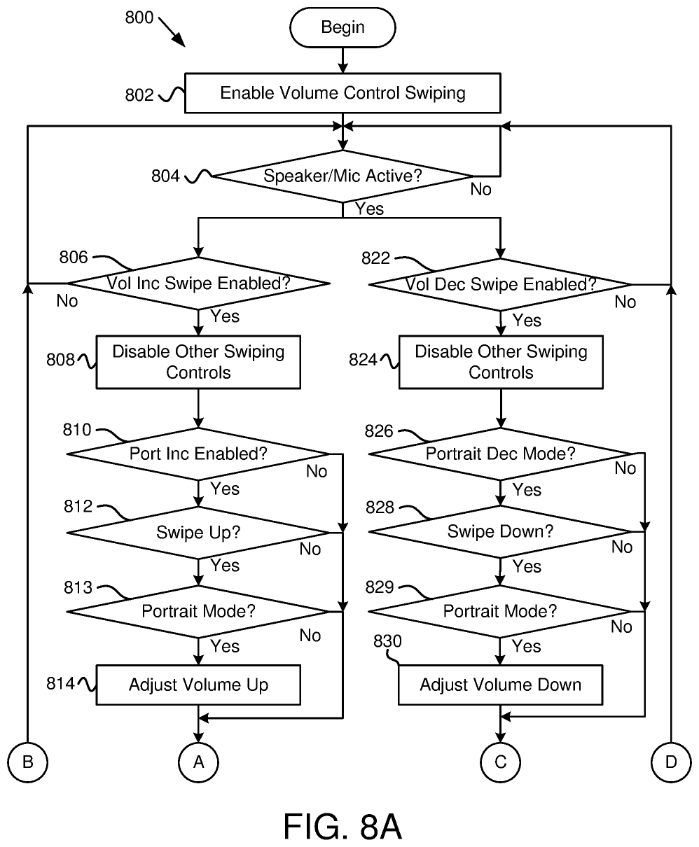

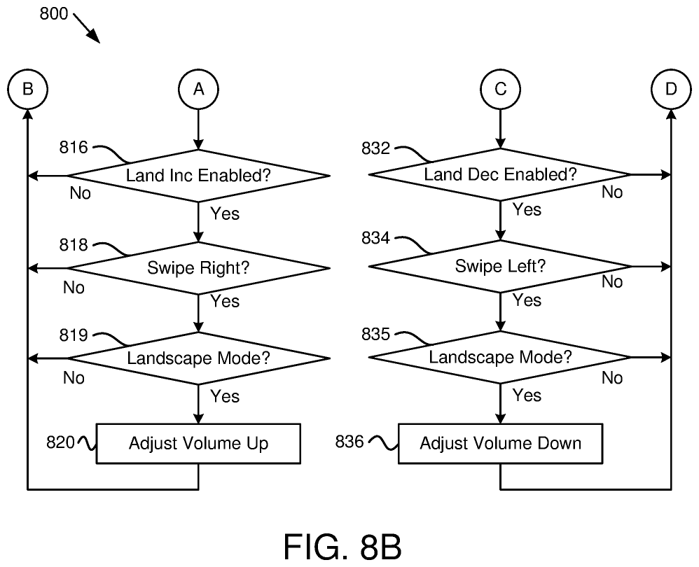

FIG. 8A is a first part and FIG. 8B is a second part of a schematic flow chart diagram illustrating a third method 800 for volume control swiping, according to various embodiments. The method 800 begins and enables 802 volume control swiping for a touchscreen 108 of a computing device 106 and detects 804 whether the speaker 116 and/or microphone 118 are active. If the method 800 detects 804 that either of the speaker 116 or microphone 118 are active, the method 800 determines 806 if volume control increase swiping is enabled. If the method 800 determines 806 that volume control increase swiping is not enabled, the method 800 returns and continues to determine 804 if the speaker 116 and/or microphone 118 are active. If the method 800 determines 806 that volume control increase swiping is enabled, the method 800 disables 808 other swiping controls on a portion of the touchscreen 108 used for volume control swiping and determines 810 if portrait volume increase control is enabled.

If the method 800 determines 810 that portrait volume increase swiping is enabled, the method 800 detects 812 if swiping on the touchscreen 108 is in a first portrait direction, such as up in a direction from bottom to top. If the method 800 detects 812 swiping on the touchscreen 108 that is in the first portrait direction, the method 800 determine 813 if the computing device 106 is operating in portrait mode. If the method 800 determines 813 that the computing device 106 is operating in portrait mode, the method 800 adjusts 814 up a volume setting on the computing device 106 and (follow A on FIG. 8A to A on FIG. 8B) determines 816 if landscape volume increase control is enabled. If the method 800 determines 810 that portrait volume increase control is not enabled, detects 812 swiping that is not in the first portrait direction, or determines 813 that the computing device 106 is not in portrait mode, the method 800 (follow A on FIG. 8A to A on FIG. 8B) determines 816 if landscape volume increase control is enabled.

If the method 800 determines 816 that landscape volume increase control is not enabled, the method 800 returns (follow B on FIG. 8B to B on FIG. 8A) and continues to detect 804 if the speaker 116 and/or microphone 118 are active. If the method 800 determines 816 that that landscape volume increase control is enabled, the method 800 detects 818 if swiping on the touchscreen 108 is in a first landscape direction, such as from left to right. If the method 800 detects 818 swiping that is not in the first landscape direction, the method 800 returns (follow B on FIG. 8B to B on FIG. 8A) and continues to detect 804 if the speaker 116 and/or microphone 118 are active. If the method 800 detects 818 swiping in the first portrait direction, the method 800 determines 819 if the computing device 106 is operating in landscape mode. If the method 800 determines 819 that the computing device 106 is not operating in landscape mode, the method 800 returns (follow B on FIG. 8B to B on FIG. 8A) and continues to detect 804 if the speaker 116 and/or microphone 118 are active. If the method 800 determines 819 that the computing device 106 is operating in landscape mode, the method 800 adjusts 820 up the volume setting on the computing device 106 and returns (follow B on FIG. 8B to B on FIG. 8A) and continues to detect 804 if the speaker 116 and/or microphone 118 are active.

If the method 800 detects 804 that either of the speaker 116 or microphone 118 are active, the method 800 also determines 822 if volume control decrease swiping is enabled. If the method 800 determines 822 that volume control decrease swiping is not enabled, the method 800 returns and continues to detect 804 if the speaker 116 and/or microphone 118 are active. If the method 800 determines 822 that volume control decrease swiping is enabled, the method 800 disables 824 other swiping controls on a portion of the touchscreen 108 used for volume control swiping and determines 826 if portrait volume increase control is enabled.

If the method 800 determines 826 that portrait volume decrease swiping is enabled, the method 800 detects 828 if swiping on the touchscreen 108 is in a second portrait direction, such as down in a direction from top to bottom. If the method 800 detects 828 swiping on the touchscreen 108 that is in the second portrait direction, the method 800 determines 829 if the computing device 106 is operating in portrait mode. If the method 800 determines 829 that the computing device 106 is operating in portrait mode, the method 800 adjusts 830 down the volume setting on the computing device 106 and (follow C on FIG. 8A to C on FIG. 8B) determines 832 if landscape volume decrease control is enabled. If the method 800 determines 826 that portrait volume decrease control is not enabled, detects 828 swiping that is not in the second portrait direction, or determines 829 that the computing device 106 is not in portrait mode, the method 800 (follow C on FIG. 8A to C on FIG. 8B) determines 832 if landscape volume decrease control is enabled.

If the method 800 determines 832 that landscape volume decrease control is not enabled, the method 800 returns (follow D on FIG. 8B to D on FIG. 8A) and continues to detect 804 if the speaker 116 and/or microphone 118 are active. If the method 800 determines 832 that that landscape volume decrease control is enabled, the method 800 detects 834 if swiping on the touchscreen 108 is in the second landscape direction, such as from right to left. If the method 800 detects 834 swiping that is not in the second landscape direction, the method 800 returns (follow D on FIG. 8B to D on FIG. 8A) and continues to detect 804 if the speaker 116 and/or microphone 118 are active. If the method 800 detects 834 swiping that is in the second landscape direction, the method 800 determines 835 if the computing device 106 is operating in landscape mode. If the method 800 determines 835 that the computing device 106 is not operating in landscape mode, the method 800 returns (follow D on FIG. 8B to D on FIG. 8A) and continues to detect 804 if the speaker 116 and/or microphone 118 are active. If the method 800 determines 835 that the computing device 106 is operating in landscape mode, the method 800 adjusts 836 down the volume setting on the computing device 106 and returns (follow D on FIG. 8B to D on FIG. 8A) and continues to detect 804 if the speaker 116 and/or microphone 118 are active.

In various embodiments, all or a portion of the method 800 is implemented using the landscape swipe enable module 202, the portrait swipe enable module 204, the speaker detection module 206, the landscape swipe module 208, the portrait swipe module 210, the volume adjustment module 212, swipe enable module 302, the volume increase module 304, the volume decrease module 306, the microphone detection module 308, the portrait/landscape detection module 310, and/or the command disable module 312.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising:
enabling volume control swiping for a landscape mode and/or a portrait mode of a touchscreen of a computing device; and
in response to detecting a speaker being active during execution of an application on the computing device:
detecting swiping on the touchscreen in a landscape direction during operation of the computing device in the landscape mode;
in response to the volume control swiping being enabled for the landscape mode, adjusting a volume setting of the computing device in response to the detected swiping of the touchscreen in the landscape direction;
detecting swiping on the touchscreen in a portrait direction during operation of the computing device in the portrait mode; and
in response to volume control swiping being enabled for the portrait mode, adjusting the volume setting of the computing device in response to the detected swiping of the touchscreen in the portrait direction.

2. The method of claim 1, wherein the detecting of the speaker of the computing device being active during execution of the application further comprises the detecting of the speaker of the computing device being active during execution of the application and/or detecting of a microphone of the computing device being active during the execution of the application, and wherein the detecting of the swiping on the touchscreen in the landscape direction and/or the portrait direction and subsequent adjusting the volume setting of the computing device are in response to the detecting of the speaker being active and/or the detection of the microphone being active.

3. The method of claim 2, wherein enabling the volume control swiping for the landscape mode and/or the portrait mode and detecting the speaker being active and/or detecting the microphone being active disables at least a portion of touchscreen commands responsive to detected swiping the landscape direction and/or the portrait direction.

4. The method of claim 1, further comprising enabling volume control swiping on the computing device, wherein the enabling of the volume control swiping for the landscape mode and/or the portrait mode is operable in response to the enabling of the volume control swiping.

5. The method of claim 1, wherein:
the detecting swiping on the touchscreen in the landscape direction during operation of the computing device in the landscape mode comprises detecting swiping on the touchscreen in the landscape direction in a first landscape direction and wherein the adjusting of the volume setting of the computing device in response to the detected swiping of the touchscreen in the landscape direction comprises increasing the volume setting of the computing device in response to the detecting of the swiping in the first landscape direction; and
the detecting swiping on the touchscreen in the landscape direction during operation of the computing device in the landscape mode comprises detecting swiping on the touchscreen in the landscape direction in a second landscape direction opposite the first landscape direction and wherein the adjusting of the volume setting of the computing device in response to the detected swiping of the touchscreen in the landscape direction comprises decreasing the volume setting of the computing device in response to the detecting of the swiping in the second landscape direction.

6. The method of claim 1, wherein:
the detecting swiping on the touchscreen in the portrait direction during operation of the computing device in the portrait mode comprises detecting swiping on the touchscreen in the portrait direction in a first portrait direction and wherein the adjusting of the volume setting of the computing device in response to the detected swiping of the touchscreen in the portrait direction comprises increasing the volume setting of the computing device in response to the detecting of the swiping in the first portrait direction; and
the detecting swiping on the touchscreen in the portrait direction during operation of the computing device in the portrait mode comprises detecting swiping on the touchscreen in the portrait direction in a second portrait direction opposite the first portrait direction and wherein the adjusting of the volume setting of the computing device in response to the detected swiping of the touchscreen in the portrait direction comprises decreasing the volume setting of the computing device in response to the detecting of the swiping in the second portrait direction.

7. The method of claim 1, wherein the detected swiping in the landscape direction and/or the detected swiping in the portrait direction exclude:
detecting swiping on a scroll bar displayed on the touchscreen;
detecting swiping on an application control display on the touchscreen; and
detecting swiping on an edge of the touchscreen designated for control of the computing device.

8. The method of claim 1, wherein:
in response to the volume control swiping being enabled for the landscape mode and disabled for the portrait mode and operation of the touchscreen in the portrait mode, detecting swiping on the touchscreen in the landscape direction results in no change to the volume; and/or
in response to the volume control swiping being enabled for the portrait mode and disabled for the landscape mode and operation of the touchscreen in the landscape mode, detecting swiping on the touchscreen in the portrait direction results in no change to the volume.

9. An apparatus comprising:
a processor; and
non-transitory computer readable storage media storing code, the code being executable by the processor to perform operations comprising:
enabling volume control swiping for a landscape mode and/or a portrait mode of a touchscreen of a computing device; and
in response to detecting a speaker being active during execution of an application on the computing device:
detecting swiping on the touchscreen in a landscape direction during operation of the computing device in the landscape mode;
in response to the volume control swiping being enabled for the landscape mode, adjusting a volume setting of the computing device in response to the detected swiping of the touchscreen in the landscape direction;
detecting swiping on the touchscreen in a portrait direction during operation of the computing device in the portrait mode; and
in response to volume control swiping being enabled for the portrait mode, adjusting the volume setting of the computing device in response to the detected swiping of the touchscreen in the portrait direction.

10. The apparatus of claim 9, wherein the detecting of the speaker of the computing device being active during the execution of the application further comprises the detecting of the speaker of the computing device being active during the execution of the application and/or detecting of a microphone of the computing device being active during the execution of the application, and wherein the detecting of the swiping on the touchscreen in the landscape direction and/or the portrait direction and subsequent adjusting the volume setting of the computing device are in response to the detecting of the speaker being active and/or the detection of the microphone being active.

11. The apparatus of claim 10, wherein enabling the volume control swiping for the landscape mode and/or the portrait mode and detecting the speaker being active and/or detecting the microphone being active disables at least a portion of touchscreen commands responsive to detected swiping the landscape direction and/or the portrait direction.

12. The apparatus of claim 9, the operations further comprising enabling volume control swiping on the computing device, wherein the enabling of the volume control swiping for the landscape mode and/or the portrait mode is operable in response to the enabling of the volume control swiping.

13. The apparatus of claim 9, wherein:
the detecting swiping on the touchscreen in the landscape direction during operation of the computing device in the landscape mode comprises detecting swiping on the touchscreen in the landscape direction in a first landscape direction and wherein the adjusting of the volume setting of the computing device in response to the detected swiping of the touchscreen in the landscape direction comprises increasing the volume setting of the computing device in response to the detecting of the swiping in the first landscape direction; and
the detecting swiping on the touchscreen in the landscape direction during operation of the computing device in the landscape mode comprises detecting swiping on the touchscreen in the landscape direction in a second landscape direction opposite the first landscape direction and wherein the adjusting of the volume setting of the computing device in response to the detected swiping of the touchscreen in the landscape direction comprises decreasing the volume setting of the computing device in response to the detecting of the swiping in the second landscape direction.

14. The apparatus of claim 9, wherein:
the detecting swiping on the touchscreen in the portrait direction during operation of the computing device in the portrait mode comprises detecting swiping on the touchscreen in the portrait direction in a first portrait direction and wherein the adjusting of the volume setting of the computing device in response to the detected swiping of the touchscreen in the portrait direction comprises increasing the volume setting of the computing device in response to the detecting of the swiping in the first portrait direction; and
the detecting swiping on the touchscreen in the portrait direction during operation of the computing device in the portrait mode comprises detecting swiping on the touchscreen in the portrait direction in a second portrait direction opposite the first portrait direction and wherein the adjusting of the volume setting of the computing device in response to the detected swiping of the touchscreen in the portrait direction comprises decreasing the volume setting of the computing device in response to the detecting of the swiping in the second portrait direction.

15. The apparatus of claim 9, wherein the detected swiping in the landscape direction and/or the detected swiping in the portrait direction exclude:
detecting swiping on a scroll bar displayed on the touchscreen;
detecting swiping on an application control display on the touchscreen; and
detecting swiping on an edge of the touchscreen designated for control of the computing device.

16. The apparatus of claim 9, wherein:
in response to the volume control swiping being enabled for the landscape mode and disabled for the portrait mode and operation of the touchscreen in the portrait mode, detecting swiping on the touchscreen in the landscape direction results in no change to the volume; and/or
in response to the volume control swiping being enabled for the portrait mode and disabled for the landscape mode and operation of the touchscreen in the landscape mode, detecting swiping on the touchscreen in the portrait direction results in no change to the volume.

17. A program product comprising a non-transitory computer readable storage medium storing code, the code being configured to be executable by a processor to perform operations comprising:
enabling volume control swiping for a landscape mode and/or a portrait mode of a touchscreen of a computing device; and
in response to detecting a speaker being active during execution of an application on the computing device:
detecting swiping on the touchscreen in a landscape direction during operation of the computing device in the landscape mode;
in response to the volume control swiping being enabled for the landscape mode, adjusting a volume setting of the computing device in response to the detected swiping of the touchscreen in the landscape direction;
detecting swiping on the touchscreen in a portrait direction during operation of the computing device in the portrait mode; and
in response to volume control swiping being enabled for the portrait mode, adjusting the volume setting of the computing device in response to the detected swiping of the touchscreen in the portrait direction.

18. The program product of claim 17, wherein the detecting of the speaker of the computing device being active during the execution of the application further comprises the detecting of the speaker of the computing device being active during the execution of the application and/or detecting of a microphone of the computing device being active during the execution of the application, and wherein the detecting of the swiping on the touchscreen in the landscape direction and/or the portrait direction and subsequent adjusting the volume setting of the computing device are in response to the detecting of the speaker being active and/or the detection of the microphone being active.

19. The program product of claim 17, the operations further comprising enabling volume control swiping on the computing device, wherein the enabling of the volume control swiping for the landscape mode and/or the portrait mode is operable in response to the enabling of the volume control swiping.

20. The program product of claim 17, wherein:
the detecting swiping on the touchscreen in the landscape direction during operation of the computing device in the landscape mode comprises detecting swiping on the touchscreen in the landscape direction in a first landscape direction and wherein the adjusting of the volume setting of the computing device in response to the detected swiping of the touchscreen in the landscape direction comprises increasing the volume setting of the computing device in response to the detecting of the swiping in the first landscape direction;
the detecting swiping on the touchscreen in the landscape direction during operation of the computing device in the landscape mode comprises detecting swiping on the touchscreen in the landscape direction in a second landscape direction opposite the first landscape direction and wherein the adjusting of the volume setting of the computing device in response to the detected swiping of the touchscreen in the landscape direction comprises decreasing the volume setting of the computing device in response to the detecting of the swiping in the second landscape direction;
the detecting swiping on the touchscreen in the portrait direction during operation of the computing device in the portrait mode comprises detecting swiping on the touchscreen in the portrait direction in a first portrait direction and wherein the adjusting of the volume setting of the computing device in response to the detected swiping of the touchscreen in the portrait direction comprises increasing the volume setting of the computing device in response to the detecting of the swiping in the first portrait direction; and
the detecting swiping on the touchscreen in the portrait direction during operation of the computing device in the portrait mode comprises detecting swiping on the touchscreen in the portrait direction in a second portrait direction opposite the first portrait direction and wherein the adjusting of the volume setting of the computing device in response to the detected swiping of the touchscreen in the portrait direction comprises decreasing the volume setting of the computing device in response to the detecting of the swiping in the second portrait direction.
